(19) United States
(12) Patent Application Publication
(10) Pub. No.: US 2016/0085242 A1
(43) Pub. Date: Mar. 24, 2016

(54) METHOD AND SYSTEM FOR PREVENTING JAMMING OF LOCKING PIN

(71) Applicants: HYUNDAI MOTOR COMPANY, Seoul (KR); Kia Motors Corporation, Seoul (KR)

(72) Inventors: Sung Joo KIM, Seoul (KR); Hyun KIM, Hwaseong-si (KR)

(21) Appl. No.: 14/549,484

(22) Filed: Nov. 20, 2014

(30) Foreign Application Priority Data
Sep. 24, 2014 (KR) 10-2014-0127447

(51) Int. Cl. G05D 7/06; G05B 15/02

(52) U.S. Cl. CPC G05D 7/0635; G05B 15/02

(57) ABSTRACT

A method is disclosed for preventing jamming of a locking pin in a continuously variable valve timing apparatus which removes a friction force by a control application logic in a direction opposite to a target rotation direction of a cam.

This will prevent jamming of a locking pin due to the friction force in the rotation direction of the cam.

### CROSS REFERENCE TO RELATED APPLICATION

The present application claims priority of Korean Patent Application Number 10-2014-0127447 filed on Sep. 24, 2014, the entire contents of which application are incorporated herein for all purposes by this reference.

### TECHNICAL FIELD

The present disclosure relates to a method and a system for preventing jamming of a locking pin, and more particularly, to a method and a system for preventing jamming of a locking pin by removing a friction force and then applying a releasing signal of the locking pin by first transmitting a control application signal in an opposite direction to a set target direction of a cam.

### BACKGROUND

To help an understanding of the present inventive concept, a locking pin of a continuously variable valve timing (CVVT)apparatus will be first described below.

Generally, a CVVT apparatus is a system which changes a phase of a cam shaft depending on engine RPM and a load state of a vehicle to continuously change opening and closing timing of a valve.

As illustrated in FIG. 1, the existing CVVT apparatus 101 of a vehicle largely includes a crank angle sensor (not shown) configured to sense a rotation angle of a crank shaft, a cam angle sensor (not shown) configured to sense a rotation angle of a cam shaft 104, a variable valve timing unit 150 configured to be connected to one side of the cam shaft 104 by a timing belt to advance or retard the cam shaft 104, and an engine control unit (ECU) configured to control an oil control valve 108 to supply oil to an advance chamber 111a or a retard chamber 111b of the variable valve timing unit 150 based on signals of the crank angle sensor and the cam angle sensor.

The variable valve timing unit 150 includes a stator 110 configured to be connected by the timing belt (not shown) to receive a rotation force of the crank shaft and a vane-shaped rotor 120 configured to be integrally coupled with the cam shaft 104 to relatively rotate with respect to the stator 110.

The stator 110 is provided with a chamber 111 which is divided into the advance chamber 111a and the retard chamber 111b by the rotor 120 and when oil is supplied to the advance chamber 111a through the oil control valve 108, the cam shaft 104 rotates due to a phase difference occurring between the rotor 120 and the stator 110, and as a result, the timing of the valve is changed.

Further, when oil is introduced into the retard chamber 111b through the oil control valve 108, the phase difference occurs between the rotor 120 and the stator 110 in an opposite direction thereto, and as a result the timing of the valve is deferred.

The rotor 120 is provided with a locking pin 131 so that the rotor 120 is locked to the stator 110 when an engine is stalled and the stator 10 is provided with a pin locking part (not illustrated) to which the locking pin 131 is locked.

However, the existing CVVT apparatus 101 of the vehicle has a problem in that the locking pin 131 1) may not be properly locked to the pin locking part when the engine is stalled, 2) may not move due to a physical limitation even by an electronic control, or 3) may be stuck due to foreign materials therearound.

Meanwhile, to electronically control a lock/unlock operation of the locking pin to a locking pin hole formed in the rotor, the ECU performs a control while turning on/off a power supply of a solenoid.

However, there may be a problem in that when the cam is driven before the locking pin completely exits from the locking pin hole, the locking pin is physically jammed to devices around the locking pin or stuck due to foreign materials to prevent the locking pin from exiting from the locking pin hole, or the like. As such, when the locking pin does not exit from the locking pin hole, since the CVVT apparatus is not operated and a position of the cam does not smoothly reach a target value set by the CVVT apparatus, an engine warning lamp is lit, necessitating that a driver go to a car repair shop to receive an after service.

A state showing the problem that the locking pin is jammed to the locking pin hole formed in the rotor is illustrated in FIG. 2.

Under working conditions, the locking pin moves downward with respect to the locking pin hole, and as a result, the locking pin is released from the locking pin hole, allowing the cam shaft 104 to rotate in an advance direction or a retard direction as directed by the CVVT apparatus. However, when oil is supplied to the oil control valve before the locking pin is released from the locking pin hole, the locking pin may not be released. In this case, a side force, due to the rotation of the rotor, pushes the locking pin against a wall of the locking pin hole. Since the side force is greater than the downward unlocking force applied to the locking pin, the locking pin becomes jammed in the hole.

In the situation described above, when the locking pin does not exit from the locking pin hole, the CVVT apparatus is not operated and the position of the cam does not smoothly reach the target value set by the CVVT apparatus. The engine warning lamp is then lit necessitating that the driver go to a car repair shop to receive an after service.

The matters described as the related art have been provided only for assisting in the understanding for the background of the present disclosure and should not be considered as corresponding to the related art known to those skilled in the art.

### SUMMARY

The present disclosure relates to the method and system for preventing a jam of a locking pin by first removing the friction force by controlling the rotation of the cam in the opposite direction to the target direction of the cam prior to rotating the cam in the advance direction or the retard direction of the cam by the control of the CVVT apparatus, moving the locking pin downward with respect to the locking pin hole by the release control of the locking pin to perform the release control thereof, and then performing the control of the cam in the original target direction to solve the jam problem of the locking pin.

An object of the present disclosure is to provide a method and a system for preventing jamming of a locking pin in a locking pin hole due to a friction force generated by a rotation of the cam by removing the friction force generated between the locking pin and a locking pin hole by applying a control signal in an opposite direction to an initial target direction of a cam and then applying a release signal of the locking pin in order to solve jamming of the locking pin caused by applying a control signal of CVVT apparatus before the locking pin is released.

A method for preventing jamming of a locking pin is introduced.

According to an exemplary embodiment of the present inventive concept, there is provided a method for preventing jamming of a locking pin in a continuously variable valve timing apparatus, wherein a friction force is removed by a control application logic by exerting a force in an opposite direction to a target rotation direction of a cam. The control application logic may include: a direction detecting step of detecting the target rotation direction of the cam; and a friction removing step of rotating the cam in an opposite direction to the target rotation direction of the cam detected by the direction detecting step.

The method may further include: prior to the direction detecting step, releasing the locking pin from a locking pin hole.

Alternatively, the method may include the locking pin from a locking pin hole after the friction removing step.

The method may further include: after the friction removing step, a determining step of determining that a removal of the friction force between the locking pin and a delay time is larger than a set reference value. The delay time may be defined as the time since the beginning of the friction removing step. After the determining step, the locking pin may be released from the locking pin hole.

The method may further include rotating the cam in the target rotation direction, when it is determined that the friction force removal between the locking pin and the locking pin hole is completed.

Meanwhile, a system for preventing jamming of a locking pin is introduced.

According to another exemplary embodiment of the present inventive concept, there is provided a system for preventing jamming of a locking pin, including: a direction controller and a locking pin controller. The direction controller may be configured to rotate a cam in an opposite direction to a target direction to remove a friction force between the locking pin and the locking pin hole. The direction controller may be further configured to transmit a friction force removal signal to the locking pin controller. The locking pin controller may be configured to receive the friction force removal signal and release the locking pin from the locking pin hole.

The direction controller may be configured to detect the target rotation direction of the cam and apply a first rotation current to an oil control valve in order to rotate the cam in the opposite direction to the target rotation direction.

The direction controller may be further configured to determine that the friction force generated between the locking pin hole and the locking pin is removed when the delay time am exceeds a reference value. The direction controller may be configured to transmit a determination signal to the locking pin controller.

The locking pin controller may be configured to apply a release current to a solenoid to release the locking pin from the locking pin hole.

The direction controller may be configured to apply a second rotation current to the oil control valve to rotate the cam in the target direction after the locking pin is released.

At least one signal may be transmitted and received between the direction controller and the locking pin controller via an integrated controller. When the direction controller detects the target rotation direction of the cam, the integrated controller may transmit a first rotation signal to the direction controller. At the same time, the integrated controller may transmit a release signal to the locking pin controller. When the delay time exceeds a set reference value, the integrated controller may transmit the release signal of the locking pin to the locking pin controller and then transmit a second rotation signal to the direction controller.

### BRIEF DESCRIPTION OF THE DRAWINGS

The above and other objects, features and advantages of the present inventive concept will be more clearly understood from the following detailed description taken in conjunction with the accompanying drawings, in which:

FIG. 1 is a configuration of a general continuously variable valve timing apparatus in the related art;

FIG. 2 is a state diagram illustrating an existing problem in the related art that a locking pin is jammed to a locking pin hole impeding the function of a CVVT apparatus;

FIG. 3 is a flow chart of a method for preventing jamming of a locking pin according to an exemplary embodiment of the present inventive concept;

FIGS. 4 and 5 are flow charts in which a releasing step is added;

FIGS. 6 to 8 are flow charts in which a determining step and a rotating step are added;

FIGS. 9 to 11 are flow charts embodying the method for preventing jamming of a locking pin according to an exemplary embodiment of the present inventive concept; and

FIGS. 12 and 13 are configuration diagrams of a system for preventing jamming of a locking pin according to an exemplary embodiment of the present inventive concept.

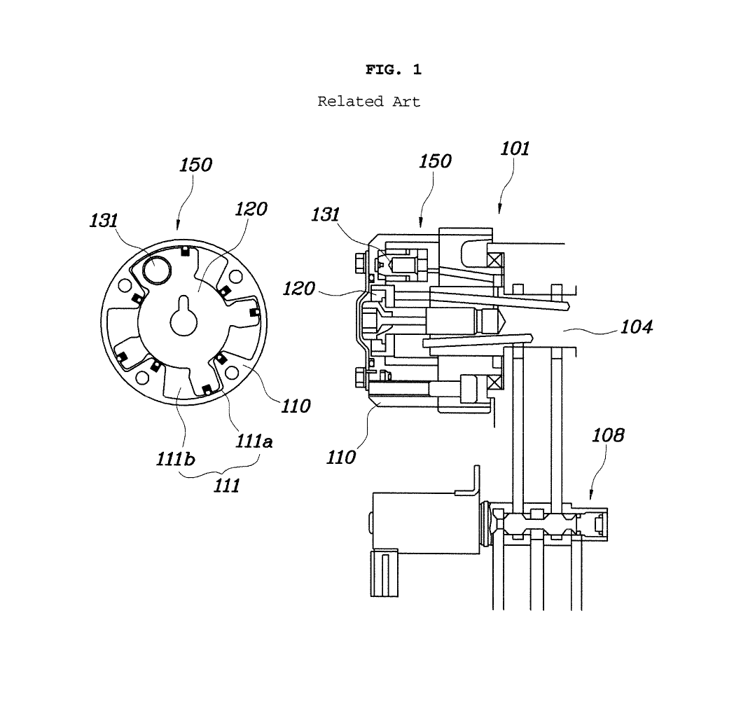

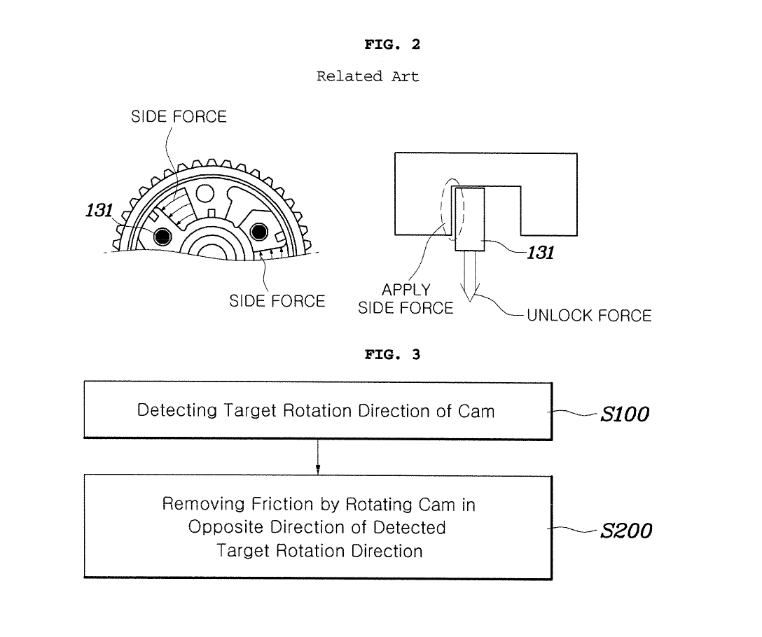

### DETAILED DESCRIPTION OF THE EMBODIMENTS

Hereinafter, a method and a system for preventing jamming of a locking pin according to exemplary embodiments of the present inventive concept will be described with reference to the accompanying drawings.

The present inventive concept is based on the technical idea that a locking pin moves downward along a locking pin hole formed in a rotor to rotate a cam in a retard direction or an advance direction before a coupling between the locking pin and the locking pin hole is released, and as a result, a side force generated by a rotation of the rotor is larger than a downward force applied to unlock the locking pin from the locking pin hole to prevent jamming phenomenon of the locking pin.

To this end, the an embodiment of the present inventive concept first temporarily induces the rotation of the cam in an opposite direction to a target direction set by the CVVT apparatus to prevent a generation of a friction force between the wall of the locking pin hole and the locking pin. An unlock release signal may then be applied to move the locking pin downward along the locking pin hole in order to release the locking pin.

To implement this, in an embodiment of the present inventive concept a control application logic commands the application of a force in an opposite direction of a CVVT apparatus-set target rotation direction of the cam to prevent the jamming of the locking pin due to the friction force in the rotation direction of the cam.

The control application logic will be described below with reference to FIG. 3 illustrated in chronological order.

As illustrated in FIG. 3, the control application logic for preventing the jamming of the locking pin largely includes a direction detecting step (S100) detecting the target rotation direction of the cam and a friction removing step (S200) temporarily rotating the cam in the opposite direction to the target rotation direction of the cam detected in the direction detecting step (S100). The target rotation direction of the cam is the desired direction of the cam performed by the operation of the CVVT apparatus. The target rotation direction of the cam may be a retarding direction or an advancing direction. The direction detecting step (S100) may confirm whether the target rotation direction of the cam is a retarding direction or an advancing direction.

The step may be performed either after the jamming of the locking pin to the locking pin hole occurs or even if jamming of the locking pin to the locking pin hole has not occurred in order to prevent the jamming in advance.

As described above, jamming of the locking pin occurs due to a friction force, since the downward unlocking force applied to release the locking pin from the locking pin hole is smaller than a side force generated by the rotation of the rotor. In step S200, the friction force is removed by rotating the cam in the opposite direction to the target rotation direction of the cam. Thus, the locking pin may move downward along the locking pin hole.

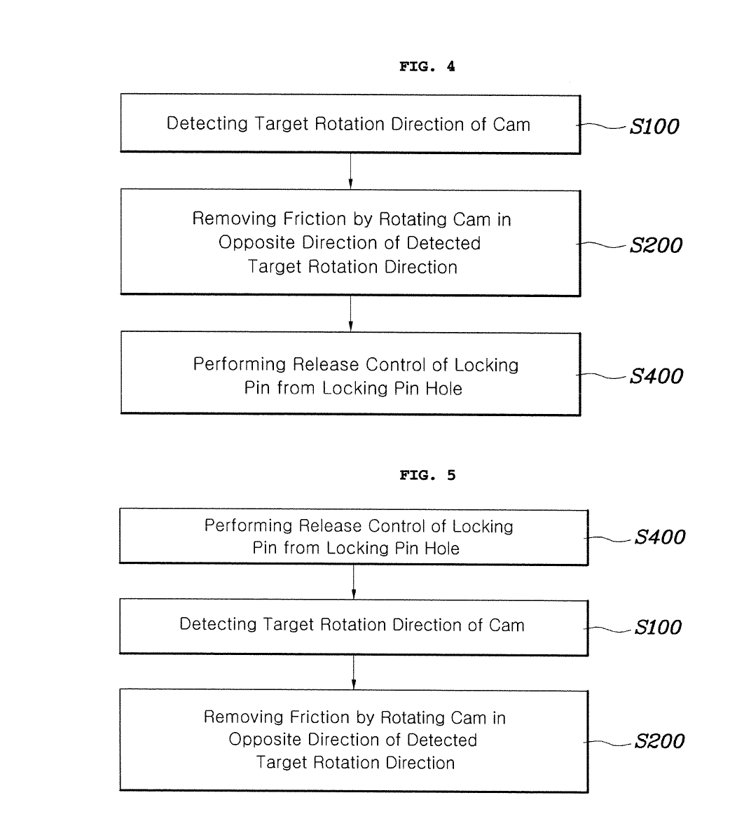

Next, after the friction force is removed, as illustrated in FIG. 4, a releasing step (S400) of moving the locking pin downward along the locking pin hole to solve the jamming phenomenon is performed.

Meanwhile, FIG. 5 is a flow chart in which the releasing step (S400) is performed prior to the direction detecting step (S100). As illustrated in FIG. 5, the releasing step is not necessarily limited to be performed after the friction removing step (S200), and therefore the releasing step (S400) may be continuously performed at any point during the claimed process and is not dependent on chronological order.

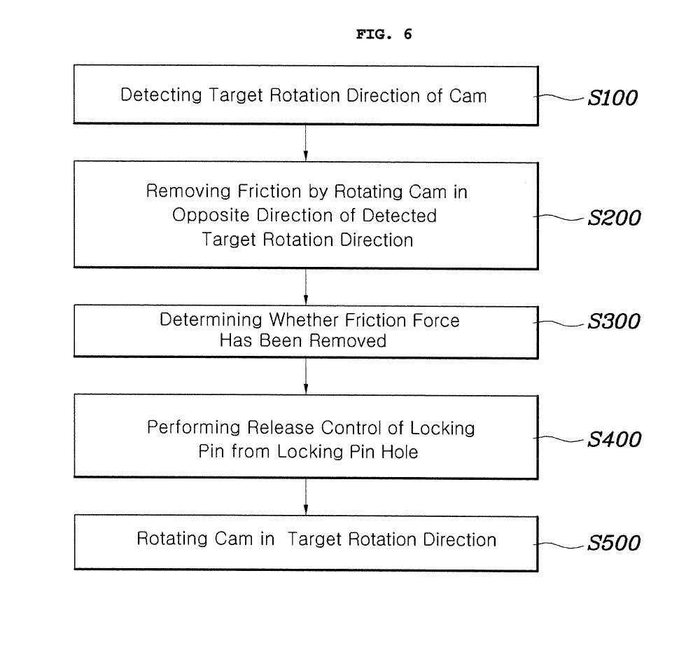

Meanwhile, FIGS. 6 to 8 are flow charts in which a friction force removal determining step (S300) and a rotating step (S500) are added. As illustrated in FIGS. 6 to 8, after the friction removing step (S200), the friction force removal determining step (S300) is performed. After the releasing step (S400), a rotating step (S500) of rotating the cam in the original target rotation direction (S500) is further included.

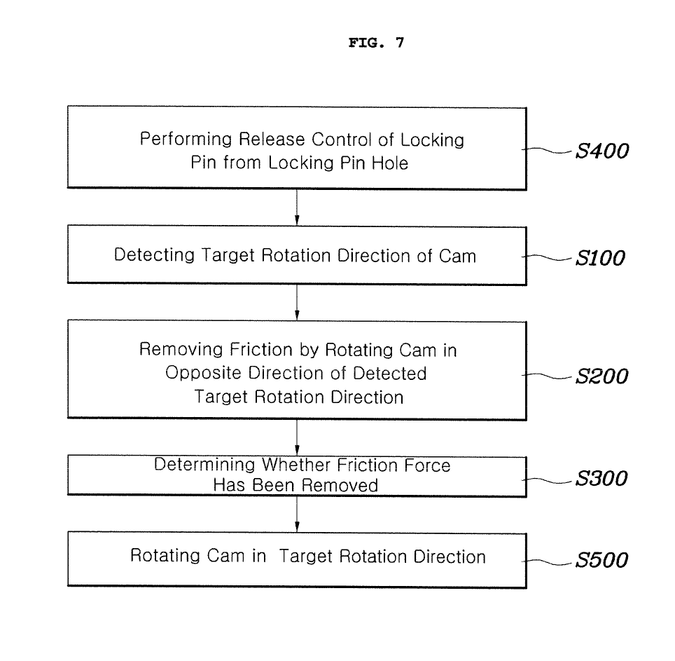

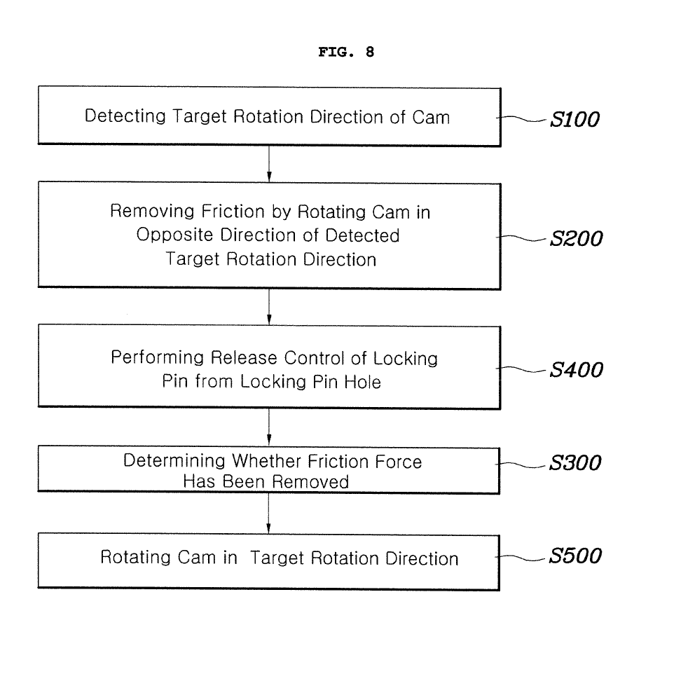

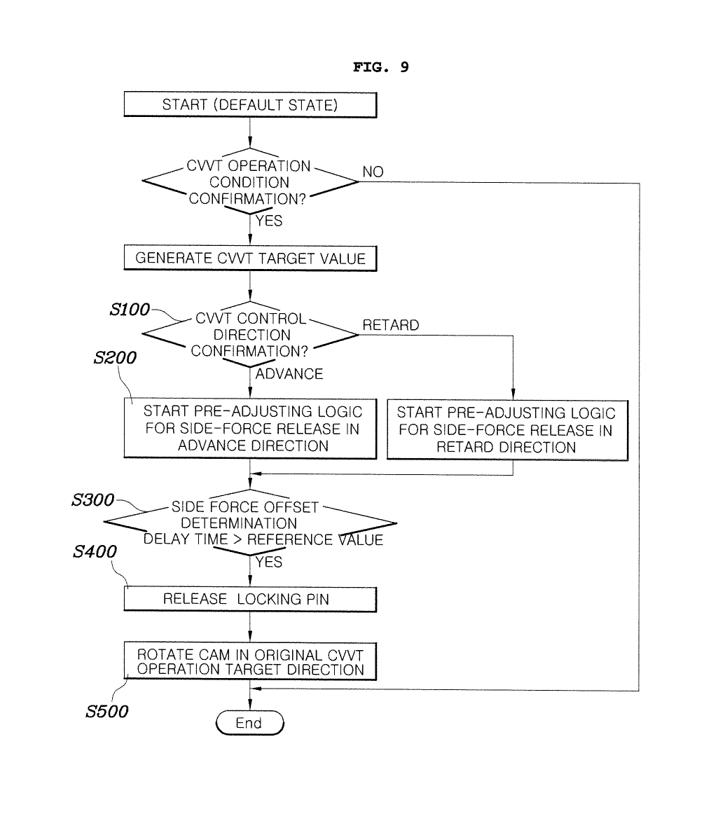

Further, referring to FIG. 7, the releasing step (S400) of performing the releasing of the locking pin from the locking pin hole is first performed and referring to FIG. 8, after the friction removing step (S200), the releasing step (S400) is performed.

The determining step (s300), which is a step of determining whether the friction removing step (s200) has been successfully performed and the above described side force has been offset, is performed after the friction removing step (S200). The determining step measures ‘delay time,’ which is time that has passed since an application of a current to a solenoid to rotate the cam in the opposite of the target rotation direction in the friction removing step (s200) until the time of measurement. During the determining step (s300), the measured delay time is then compared to a reference value. When the ‘delay time’ is larger than the reference value, it is determined that the friction force has been removed. Then, the releasing step (S400) may be performed.

The reference value is a reference time which is optimized to a minimum value based on the driving state of a vehicle and experimental research.

Meanwhile, after it is determined that the friction force is removed, the releasing step (S400) of applying, by an ECU, a current signal to the solenoid to move the locking pin downward along the locking pin hole is performed and then a rotating step (S500) of rotating the cam in the original target rotation direction is performed. In certain embodiments, the rotating step (S500) may be performed by applying a current to an oil control valve in a retard direction or an advance direction.

By the above process, when the jamming phenomenon of the locking pin occurs, a control logic in the opposite direction to the target rotation direction of the cam is performed to determine that the friction force is removed and then again rotate the cam in the original target rotation direction of the cam, thereby solving the jam problem of the locking pin.

Further, FIGS. 9 to 11 are flow charts embodying the above steps. In particular, the method for preventing jamming of a locking pin according to the present inventive concept will be described in detail in a chronological order with reference to FIG. 9.

First, it is determined whether the locking pin is in a so-called ‘default’ state in which the locking pin is jammed to the locking pin hole.

Further, as described above, even when the locking pin is not jammed to the locking pin hole, the control logic of the present inventive concept may be performed to prevent the jamming of the locking pin to the locking pin hole.

Next, a so-called ‘CVVT operation condition confirmation’ process in which the rotation of the cam starts is performed and a ‘CVVT target value’ which corresponds to the rotation direction of the cam is generated.

A ‘CVVT control direction confirmation,’ which is the direction detecting step (S100) detecting the target rotation direction of the cam, is performed. As illustrated, when the direction is confirmed as the advance direction, to remove the side force generated in the advance direction, the cam is rotated by a set angle in the opposite direction thereto, i.e. the retard direction (Friction removing step S200). When the direction is confirmed as the retard direction, the cam is rotated by a set angle in the advance direction to prevent the friction force from being generated between the locking pin and the locking pin hole (S200).

Next, the determining step (S300) determines whether the ‘delay time’ is larger than the reference value to determine whether the friction force has been removed. Then the ECU applies a current to the solenoid to control the locking pin to move downward along the locking pin hole (releasing step S400).

When the locking pin has been released, the ECU applies an oil injection signal to the oil control valve to rotate the cam in the original target rotation direction of the cam (S500) in order to compensate for the amount of time the cam was rotated in the opposite direction.

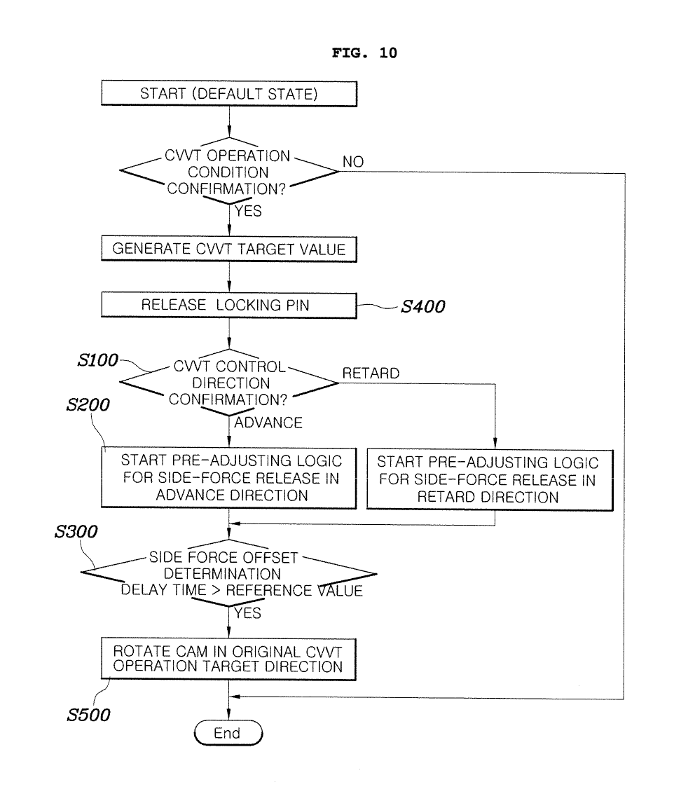

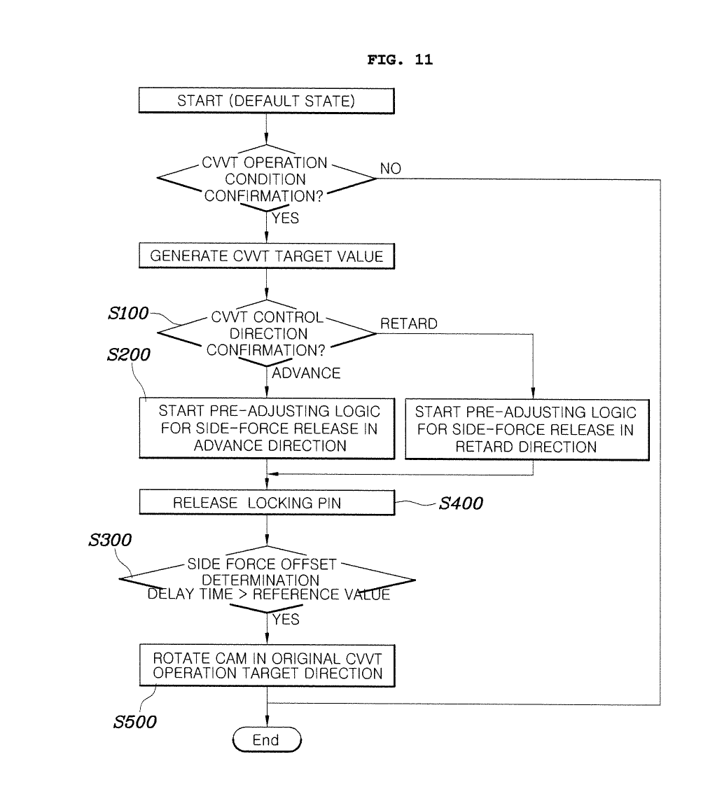

Further, referring to FIGS. 10 and 11, the releasing step (S400) may also be performed before the ‘CVVT control direction confirmation’ (S100)(FIG. 10) or after the friction removing step(S200) (FIG. 11).

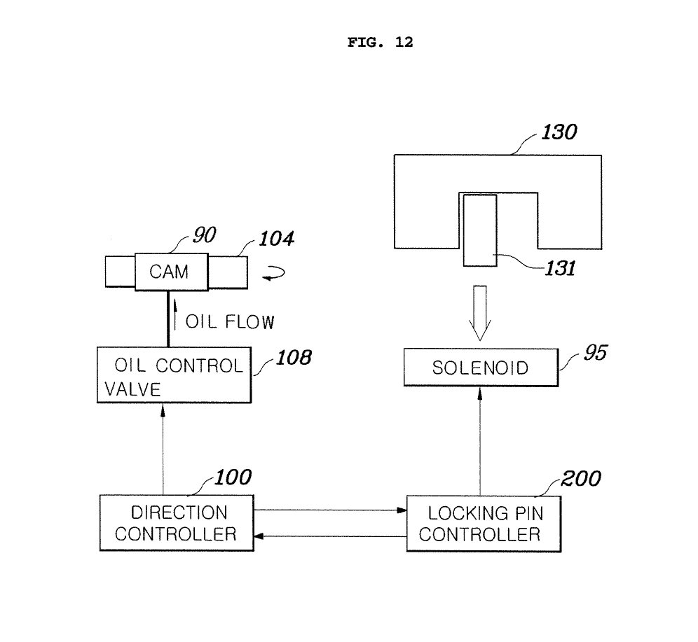

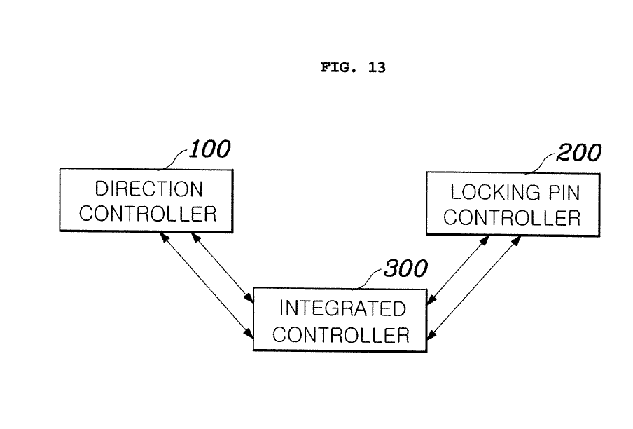

Meanwhile, FIG. 12 illustrates the overall configuration diagram of the system for preventing jamming of a locking pin according to the present inventive concept. As illustrated, the present inventive concept includes a direction controller 100 and a locking pin controller 200.

The direction controller 100 is configured to rotate the cam 90 integrally disposed on a cam shaft 104. The locking pin controller 200 is configured to release the locking pin 131 from the locking pin hole 130. The direction controller 100 is configured to rotate the cam 90 in the opposite direction to the set target rotation direction of the cam 90 to remove the friction force between the locking pin 131 and the locking pin hole 130 and then transmit the signal to the locking pin controller 200. The locking pin controller 200 is configured to receive the friction force removing signal and release the locking pin 131 from the locking pin hole 130.

In certain embodiments, the direction controller 100 and the locking pin controller 200 may be generally controlled by the ECU. The direction controller and the locking pin controller may be separate entities, or they may be combined within a single controller in certain embodiments.

Meanwhile, the direction controller 100 detects the target rotation direction of the cam 90 to apply a first rotation current to the oil control valve 108 in order to rotate the cam 90 in the opposite direction to the target direction. When the supply time of a first rotation current to the oil control valve 108 to rotate the cam 90 in the opposite direction to the target rotation direction of the cam 90 exceeds the reference value, the direction controller 100 determines that the friction force generated between the locking pin hole 130 and the locking pin 131 is removed and then transmits the determination signal to the locking pin controller 200. The aforesaid “supply time” is equivalent to the “delay time” mentioned hereinabove.

In certain embodiments, the locking pin controller 200 can be configured to apply a release current to the solenoid 95 to release the locking pin 131 from the locking pin hole 130 and the direction controller 100 can be configured to apply a second rotation current to the oil control valve 108 to rotate the cam 90 in the original target direction after the locking pin 131 is released.

Meanwhile, as illustrated in FIG. 13, a system for preventing jamming of a locking pin in a CVVT apparatus according to an exemplary embodiment of the present inventive concept transmits and receives at least one signal between the direction controller 100 and the locking pin controller 200 via an integrated controller 300. When the direction controller 100 detects the target rotation direction of the cam, the integrated controller 300 transmits a first rotation signal direction controller 100, signaling the direction controller 100 to turn the cam in the opposite direction to the target rotation direction of the cam. At the same time, the integrated controller transmits a release signal to the locking pin controller 200, signaling the release of the locking pin. When the delay time described hereinabove exceeds the reference value, the integrated controller 300 transmits the release signal to the locking pin controller 200 and then transmits a second rotation signal to the direction controller 100, signaling the rotation of the cam in the original target rotation direction.

That is, the integrated controller 300 may be configured to transmit and receive at least one signal between the direction controller 100 and the locking pin controller 200 and combine the tasks of the direction controller 100 and the locking pin controller 200.

In certain embodiments, the integrated controller 300 may be included in the general ECU and the detailed operation process thereof described herein may take place via the ECU.

According to the method and system for preventing jamming of a locking pin according to the exemplary embodiments of the present inventive concept having the configuration as described above, it is possible to optimize the effect of the CVVT system by solving the problems of the reduction of responsiveness, the weakness of operability, the engine stall, the badness of starting performance, and the like due to the sticking of the locking pin and solving the sticking of the locking pin without the driver directly going to the car repair shop.

Although the present inventive concept has been shown and described with respect to specific exemplary embodiments, it will be obvious to those skilled in the art that the present inventive concept may be variously modified and altered without departing from the spirit and scope of the present inventive concept as defined by the following claims.

What is claimed is:

1. A method for preventing jamming of a locking pin in a continuously variable valve timing apparatus, comprising removing a friction force, using a control application logic by exerting a force in a direction opposite to a target rotation direction of a cam.

2. The method of claim 1, wherein the control application logic includes:
a direction detecting step of detecting the target rotation direction of the cam; and
a friction removing step of rotating the cam in an opposite direction to the target rotation direction of the cam.

3. The method of claim 2, further comprising:
prior to the direction detecting step, releasing the locking pin from a locking pin hole.

4. The method of claim 2, further comprising:
after the friction removing step, releasing the locking pin from a locking pin hole.

5. The method of claim 2, further comprising:
after the friction removing step,
a determining step of determining that a removal of the friction force between the locking pin and a locking pin hole is completed when a delay time is larger than a reference value, where the delay time is the time since the beginning of the friction removing step; and
after the determining step, releasing the locking pin from the locking pin hole.

6. The method of claim 5, further comprising:
rotating the cam in the target rotation direction when it is determined that the removal of the friction force between the locking pin and the locking pin hole is completed.

7. A system for preventing jamming of a locking pin in a continuously variable valve timing apparatus, the system comprising: a direction controller and a locking pin controller, wherein the direction controller is configured to rotate a cam in an opposite direction to a target rotation direction and transmit a friction force removal signal to the locking pin controller, and
wherein the locking pin controller is configured to receive the friction force removal signal and release the locking pin from the locking pin hole.

8. The system of claim 7, wherein the direction controller is further configured to detect the target rotation direction of the cam and to apply a first rotation current to an oil control valve in order to rotate the cam in the opposite direction to the target rotation direction.

9. The system of claim 8, wherein the direction controller is further configured to
determine that the friction force generated between the locking pin hole and the locking pin is removed when a delay time exceeds a reference value, where the delay time is the amount of time the first rotation current has been applied to the oil control valve in order to rotate the cam in the opposite direction to the target rotation direction, and
transmit a determination signal to the locking pin controller.

10. The system of claim 9, wherein the locking pin controller is configured to apply a release current to a solenoid to release the locking pin from the locking pin hole.

11. The system of claim 10, wherein the direction controller is configured to apply a second rotation current to the oil control valve to rotate the cam in the target rotation direction after the locking pin is released.

12. The system of claim 7, wherein at least one signal is transmitted and at least one signal is received between the direction controller and the locking pin controller via an integrated controller,
when the direction controller detects a target rotation direction of the cam, the integrated controller transmits a first rotation signal to the direction controller and transmits a release signal to the locking pin controller, wherein the first rotation signal signals the direction controller to apply the first rotation current and the release signal signals the release of the locking pin, and
when the delay time exceeds a reference value, the integrated controller transmits the release to the locking pin controller and then transmits a second rotation signal to the direction controller, wherein the second rotation signals the direction controller to apply the second rotation current to the oil control valve to rotate the cam in the target rotation direction after the locking pin is released.
